(19) United States
(12) Patent Application Publication
(10) Pub. No.: US 2016/0162752 A1
(43) Pub. Date: Jun. 9, 2016

(54) RETRIEVAL APPARATUS, RETRIEVAL METHOD, AND COMPUTER PROGRAM PRODUCT

(71) Applicant: Kabushiki Kaisha Toshiba, Tokyo (JP)

(72) Inventors: Tomoyuki SHIBATA, Kawasaki Kanagawa (JP); Toshiaki NAKASU, Tokyo (JP); Yuto YAMAJI, Kawasaki Kanagawa (JP); Osamu YAMAGUCHI, Yokohama Kanagawa (JP)

(21) Appl. No.: 14/954,822

(22) Filed: Nov. 30, 2015

(30) Foreign Application Priority Data
Dec. 5, 2014 (JP) 2014-247249

(51) Int. Cl. G06K 9/46; G06T 1/00

(52) U.S. Cl. CPC G06K 9/4671; G06T 1/0007

(57) ABSTRACT

According to an embodiment, a retrieval apparatus includes a receiver, a retrieval processor, and a display controller. The receiver is configured to receive a first image. The retrieval processor is configured to retrieves a second image based on first element information, the first element information comprising one or more of a category, a position, a size, a shape, and a color associated with the first image, the first image comprising one or more first image elements. The display controller is configured to display, the second image with at least a first symbol image symbolizing the one or more first image elements on a display.

### CROSS-REFERENCE TO RELATED APPLICATIONS

This application is based upon and claims the benefit of priority from Japanese Patent Application No. 2014-247249, filed on Dec. 5, 2014; the entire contents of which are incorporated herein by reference.

### FIELD

Embodiments described herein relate generally to a retrieval apparatus, a retrieval method, and a computer program product.

### BACKGROUND Retrieval apparatuses that, with images input by users as queries, retrieve images to be searched for are conventionally known.

However, in the conventional techniques described above, users cannot understand how retrieval apparatuses have interpreted input images to retrieve images to be searched for.

### BRIEF DESCRIPTION OF THE DRAWINGS

FIG. 1 is a configuration diagram illustrating an example of a retrieval apparatus of a first embodiment;

FIG. 2 is a diagram illustrating an example of a display screen of the first embodiment;

FIG. 3 is a flowchart illustrating a processing example of the retrieval apparatus of the first embodiment;

FIG. 4 is a configuration diagram illustrating an example of a retrieval apparatus of a first modification;

FIG. 5 is a diagram illustrating an example of a display screen of the first modification;

FIG. 6 is a diagram illustrating an example of a display screen of a second modification;

FIG. 7 is a configuration diagram illustrating an example of a retrieval apparatus of a second embodiment;

FIG. 8 is a diagram illustrating an example of a query display area of the second embodiment;

FIG. 9 is a diagram illustrating an example of a symbol deleting operation of the second embodiment;

FIG. 10 is a diagram illustrating an example of a symbol color changing operation of the second embodiment; and

FIG. 11 is a diagram illustrating a hardware configuration example of the retrieval apparatuses of the embodiments and modifications.

### DETAILED DESCRIPTION

According to an embodiment, a retrieval apparatus includes a receiver, a retrieval processor, and a display controller. The receiver is configured to receive a first image. The retrieval processor is configured to retrieves a second image based on first element information, the first element information comprising one or more of a category, a position, a size, a shape, and a color associated with the first image, the first image comprising one or more first image elements. The display controller is configured to display, the second image with at least a first symbol image symbolizing the one or more first image elements on a display.

Embodiments will be described below in detail with reference to the accompanying drawings.

### First Embodiment

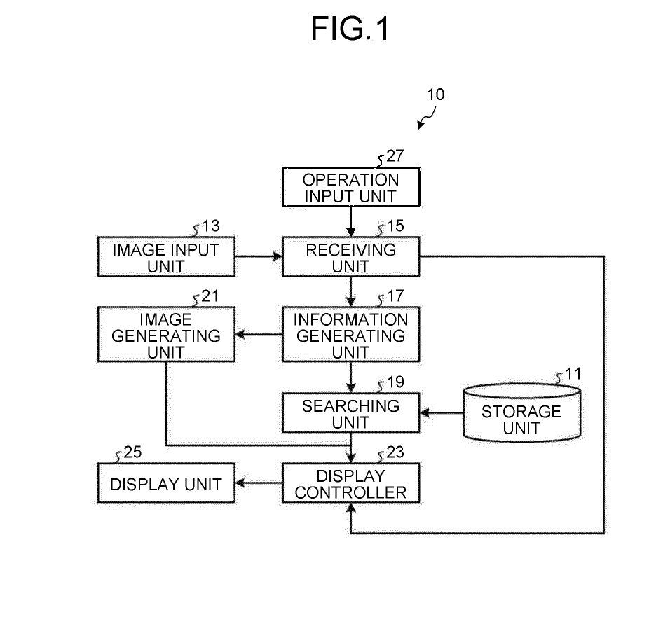

FIG. 1 is a configuration diagram illustrating an example of a retrieval apparatus 10 of a first embodiment. As illustrated in FIG. 1, the retrieval apparatus 10 includes a storage unit 11, an image input unit 13, a receiving unit 15, an information generating unit 17, a retrieval unit 19, an image generating unit 21, a display controller 23, a display unit 25, and an operation input unit 27.

The retrieval apparatus 10 can be implemented by, for example, a tablet terminal, a smart phone, or a personal computer (PC).

The storage unit 11 can be implemented by, for example, a storage apparatus capable of magnetic, optical, or electric storage such as a hard disk drive (ADD), a solid state drive (SDS), a memory card, an optical disc, a random access memory (RAM), and a read only memory (ROM). The image input unit 13 can be implemented by, for example, an imaging apparatus such as a camera, a communication apparatus such as a network interface, and the above storage apparatus.

The receiving unit 15, the information generating unit 17, the retrieval unit 19, the image generating unit 21, and the display controller 23 may be implemented by, for example, causing a processing apparatus such as a central processing unit (CPU) to execute a computer program, that is, by software, implemented with hardware such as an integrated circuit (ICE), or implemented by using software in combination with hardware.

The display unit 25 can be implemented by, for example, a display device such as a touch panel display and a liquid crystal display. The operation input unit 27 can be implemented by, for example, a touch panel display, a mouse, or a keyboard.

The storage unit 11 stores therein a plurality of images. Specifically, the storage unit 11 stores therein a plurality of records each of which associates an image, element information that is at least one of a category, a position, a size, a shape, and a color of one or more components constituting the image, and a symbol image that symbolizes the one or more components based on the element information with each other. Although, in the first embodiment, a case is described in which the element information is information indicating the category and the position of the one or more components as an example, the element information is not limited thereto.

The symbol image is an image the category of which is symbolized by a name (a keyword) of the category, an icon, an illustration, or other items for each of the one or more components. When the element information indicates the position of the component, the position of the symbol is determined to be a position corresponding to the position of the component and, when the element information indicates the size of the component, the size of the symbol is determined to be a size corresponding to the size of the component. When the element information indicates the shape of the component, the perimeter of the symbol is surrounded with a line along the shape of the component and, when the element information indicates the color of the component, the color of the symbol is determined to be a color corresponding to the color of the component.

The element information is generated from an image and is associated with the image. A process for generating it may be similar to that of the information generating unit 17. Thus, a description thereof is omitted and will be made in the information generating unit 17. The symbol image is generated from the element information and is associated with the element information. A process for generating it may be similar to that of the image generating unit 21. Thus, a description thereof is omitted and will be made in the image generating unit 21.

In the following, an image for generating a query for retrieving an image to be searched for will be referred to as a first image; one or more components constituting the first image will be referred to as one or more first components; element information that is at least one of a category, a position, a size, a shape, and a color of the one or more first components will be referred to as first element information; and a symbol image that symbolizes the one or more first components will be referred to as a first symbol image. The query for retrieving the image to be searched for corresponds to the first element information.

Similarly, an image to be searched for will be referred to as a second image; one or more components constituting the second image will be referred to as one or more second components; element information that is at least one of a category; a position, a size, a shape, and a color of the one or more second components will be referred to as second element information; and a symbol image that symbolizes the one or more second components will be referred to as a second symbol image.

The image input unit 13 inputs the first image. When an image imaged by an imaging apparatus or an image externally received by a communication apparatus is the first image, the images stored in the storage unit 11 are all second images. When the image imaged by the imaging apparatus is a moving image, any of a plurality of frame images constituting the moving image may be the first image. When any of the images stored in the storage unit 11 is the first image, all the images other than the first image among the images stored in the storage unit 11 are second images.

The receiving unit 15 receives input of the first image from the image input unit 13. The receiving unit 15 also receives various pieces of operation input from the operation input unit 27.

The information generating unit 17 generates the first element information of the one or more first components from the first image received by the receiving unit 15. The one or more first components are first components the category of which is known among a plurality of first components constituting the first image.

To generate the first element information of the one or more first components from the first image, a technique may be used that is disclosed in, for example, J. Shotton, J. Winn, C. Rother, A. Criminisi., TextonBoost for Image Understanding: Multi-Class Object Recognition and Segmentation by Jointly Modeling Texture, Layout, and Context., In IJCV.

The information generating unit 17, for example, using a discriminator that is trained so as to extract (discriminate) the range of components belonging to any of predetermined one or more categories, extracts categories and ranges of the respective one or more first components from a plurality of components constituting the first image.

The information generating unit 17 can determine the position (the central position, for example), the size, and the shape of the first component from the extracted range of the first component.

The information generating unit 17, with respect to the extracted range of the first component, generates an equally quantized color histogram in any color space such as an RGB color space, an LAB color space, and an HSV color space and can determine a representative color with the most frequent value to be the color of the first component. The color of the first component may be represented by one color, represented by distribution such as a histogram, or represented by any number of representative colors.

When any of the images stored in the storage unit 11 is the first image, the first element information of the first image is also stored in the storage unit 11, and the information generating unit 17 need not generate the first element information.

The retrieval unit 19 retrieves the second image based on the first element information of the first image received by the receiving unit 15. When the first element information is generated by the information generating unit 17, the retrieval unit 19 uses the first element information for searching for the second image, and when the first element information is stored in the storage unit 11, uses the first element information for searching for the second image.

Specifically, the retrieval unit 19 retrieves, from the storage unit 11, a record containing the second element information similar to the first element information.

The retrieval unit 19, for example, quantizes the categories and the positions of the respective one or more first components that the first element information represents. The retrieval unit 19 acquires a record from the storage unit 11 and quantizes the categories and the positions of the respective one or more second components that the second element information contained in the record represents.

Next, the retrieval unit 19 compares, for each of the one or more first components, quantized values of the category and position of the first component with the quantized values of the category and position of each of the one or more second components. If the ratio of matching quantized values is a certain ratio or more, the retrieval unit 19 determines the second component to be similar to the first component. The retrieval unit 19 sets, as similarity, the ratio of the second components matching the one or more first components. If the similarity is a threshold or more, the second element information is similar to the first element information.

In the first embodiment, an example is described in which the category and the position are quantized because the element information indicates the categories and the positions of the respective one or more components. If the element information also indicates the size, the shape, and the color of the respective one more components, the size, the shape, and the color are also quantized.

For example, the retrieval unit 19 may determine the similarity between the first component and the second component by determining whether or not a difference between the first component and the second component is within the range of a differential characteristic defined in advance. In this case, as the differential characteristic of the category, a semantic close relation between categories may be used; as the differential characteristic of the position, a distance obtained by normalizing a distance between coordinates with an image size may be used; as the differential characteristic of the size, an aspect ratio may be used; as the differential characteristic of the shape, correlation of edge information of circumscribed shapes may be used; and as the differential characteristic of the color, a color histogram may be used.

For example, the retrieval unit 19 may determine the similarity between the first component and the second component using a discriminator. In this case, a discriminator may be used that is trained by a general mechanical learning process such as support vector machine (SVM) as a 2-class problem using differential characteristics with component pairs determined to subjectively match and component pairs determined not to subjectively match as statistical data.

The image generating unit 21 generates, based on the first element information of the first image received by the receiving unit 15, the first symbol image that symbolizes the one or more first components. When the first element information is generated by the information generating unit 17, the image generating unit 21 uses the first element information for generating the first symbol image, and when the first element information is stored in the storage unit 11, the image generating unit 21 uses the first element information for generating the first symbol image.

The display controller 23 displays, on the display unit 25, an image based on the second image retrieved by the retrieval unit 19 together with the first symbol image. When the first symbol image is generated by the image generating unit 21, the display controller 23 displays the first symbol image, and when the first symbol image is stored in the storage unit 11, the display controller 23 displays the first symbol image. Although, in the first embodiment, a case is described in which the image based on the second image is the second symbol image contained in the record retrieved by the retrieval unit 19 as an example, the image based on the second image is not limited thereto.

In the first embodiment, when n (n≧2) records have been retrieved by the retrieval unit 19, the display controller 23 arranges and displays, in order of similarity, n second symbol images contained in the n records on the display unit 25, as images based on the second image.

In the first embodiment, when the second symbol image displayed on the display unit 25 is designated or selected, the display controller 23 further displays a thumbnail image of the second image contained in the record containing the second symbol image on the display unit 25. Specifically, when an operation to designate (a touching operation or a cursor overlaying operation, for example) or select (a cursor overlaying and clicking operation, for example) the second symbol image displayed on the display unit 25 is input from the operation input unit 27 and is received by the receiving unit 15, the display controller 23 acquires the second image contained in the record containing the second symbol image, reduces the second image to the thumbnail image, and further displays the thumbnail image on the display unit 25.

In the first embodiment, the display controller 23 further displays a thumbnail image of the first image received by the receiving unit 15 on the display unit 25. Specifically, the display controller 23 reduces the first image received by the receiving unit 15 to the thumbnail image and further displays the thumbnail image on the display unit 25.

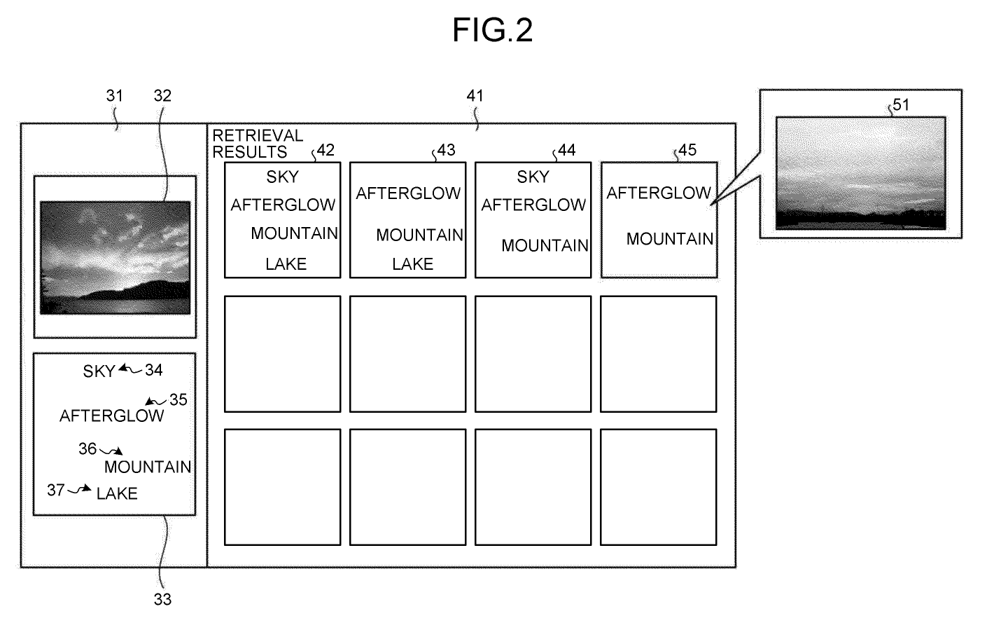

FIG. 2 is a diagram illustrating an example of a display screen of the first embodiment. In the example illustrated in FIG. 2, on a query display area 31, a thumbnail image 32 of the first image and a first symbol image 33 are displayed.

In the first symbol image 33, a symbol 34 having a category name of “sky” is arranged at a position on the first symbol image 33 corresponding to a sky of the thumbnail image 32, a symbol 35 having a category name of “afterglow” is arranged at a position on the first symbol image 33 corresponding to an afterglow of the thumbnail image 32, a symbol 36 having a category name of “mountain” is arranged at a position on the first symbol image 33 corresponding to a mountain of the thumbnail image 32, and a symbol 37 having a category name of “lake” is arranged at a position on the first symbol image 33 corresponding to a lake of the thumbnail image 32.

On a retrieval result display area 41, second symbol images 42 to 45 and other images retrieved are displayed. In the example illustrated in FIG. 2, the second symbol image 45 is selected (not illustrated), and a second image 51 contained in a record containing the second symbol image 45 is further displayed.

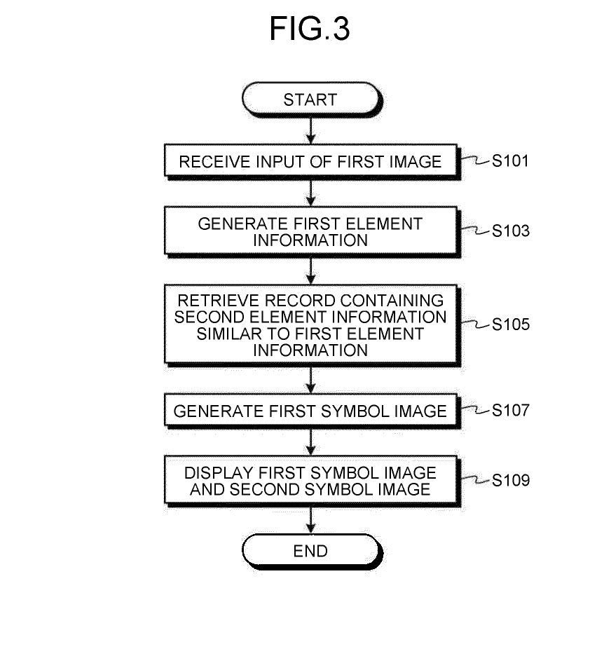

FIG. 3 is a flowchart illustrating an example of a procedure of the processing performed by the retrieval apparatus 10 of the first embodiment.

First, the receiving unit 15 receives input of the first image from the image input unit 13 (Step S101).

The information generating unit 17 then generates the first element information of the one or more first components from the first image received by the receiving unit 15 (Step S103).

The retrieval unit 19 then retrieves, using the first element information generated by the information generating unit 17, a record containing the second element information similar to the first element information, the second image, and the second symbol image (Step S105).

The image generating unit 21 then generates, based on the first element information generated by the information generating unit 17, the first symbol image that symbolizes the one or more first components (Step S107).

The display controller 23 then displays the first image received by the receiving unit 15, the first symbol image generated by the image generating unit 21, and the second symbol image retrieved by the retrieval unit 19 on the display unit 25 (Step S109).

The steps in the flowchart may be executed in a changed order or simultaneously executed, unless contrary to the nature thereof. For example, the generation (the processing at Step S107) of the first symbol image may be executed at any timing at and after Step S103 and at and before Step S109. For example, the display of the first image may be executed at any timing at and after Step S101, the display of the first symbol image may be executed at any timing after the generation of the first symbol image, and the display of the second symbol image may be executed at any timing at and after Step S105.

As described above, according to the first embodiment, together with the image based on the second image retrieved based on the first element information that is at least one of the category, the position, the size, the shape, and the color of the one or more first components constituting the first image, the first symbol image that symbolizes the one or more first components is displayed, and thus the user is enabled to understand how the first image has been interpreted to retrieve the second image. Consequently, the user is enabled to easily intuitively understand the reason why the second image has been retrieved from the first image.

First Modification

In the first embodiment, instead of displaying all the second symbol images retrieved, representative symbol images less than the number of the second symbol images retrieved and number information that indicates the number of the second symbol images classified into the respective representative symbol images may be displayed. The following mainly describes points of difference from the first embodiment. Components having functions similar to those of the first embodiment will be attached with names and numerals similar to those of the first embodiment, and descriptions thereof will be omitted.

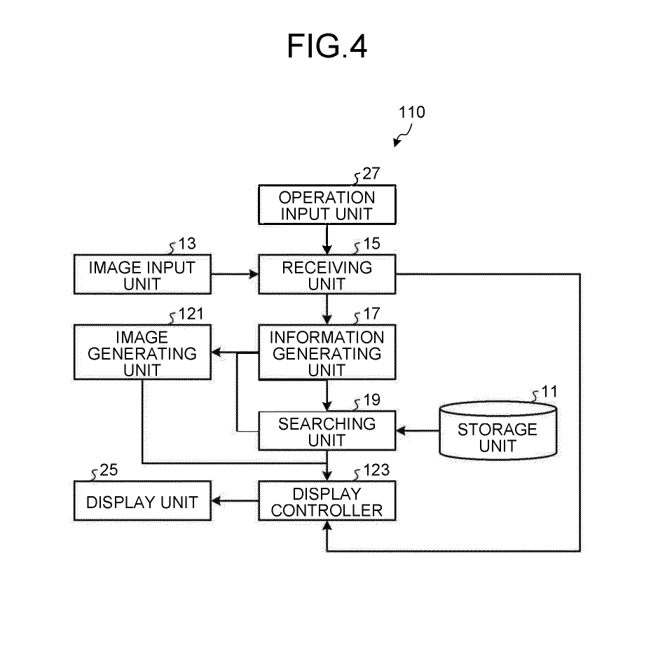

FIG. 4 is a configuration diagram illustrating an example of a retrieval apparatus 110 of a first modification. As illustrated in FIG. 4, the retrieval apparatus 110 of the first modification is different from the first embodiment in an image generating unit 121 and a display controller 123.

When n records have been retrieved by the retrieval unit 19, the image generating unit 121 may further generate m (2≦m≦n) representative symbol images based on the generated first symbol image or the n second symbol images contained in the n records.

When generating the representative symbol images from the first symbol image, the image generating unit 121 may change at least one of a category, a position, a size, a shape, and a color of a symbol of the first symbol image to generate the m representative symbol images.

When generating the representative symbol images from the n second symbol images, the image generating unit 121 may classify the n second symbol images into m groups based on similarity or other characteristics, combine the second symbol images classified into each group, and generate the m representative symbol images.

The display controller 123 may classify the n second symbol images retrieved by the retrieval unit 19 into the m representative symbol images and display, as images based on the second image, number information indicating the number of the second symbol images classified into each of the m representative images together with the m representative symbol images on the display unit 25. When the classification of the n second symbol images has been performed by the image generating unit 121, the display controller 123 may omit the classification.

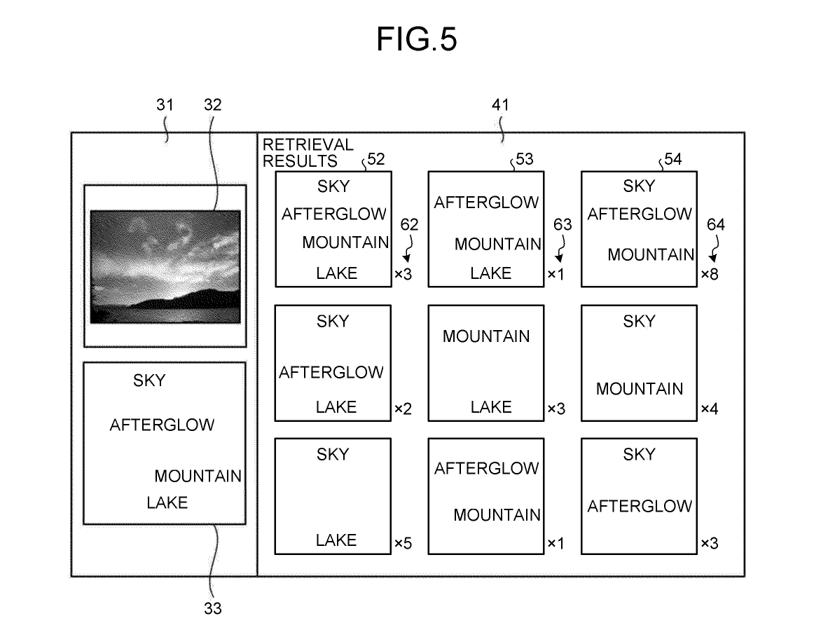

FIG. 5 is a diagram illustrating an example of a display screen of the first modification. In the example illustrated in FIG. 5, on the retrieval result display area 41, generated representative symbol images 52 to 54 and other images are displayed, and pieces of number information 62 to 64 are displayed in association with the representative symbol images 52 to 54, respectively.

Second Modification

In the first embodiment, the first image and the second image may be face images. In this case, the first element information can be at least one of the category, the position, the size, the shape, and the color of the one or more first components constituting the first image and a category of the first image.

Examples of the category of the first image include a smiling face and feelings such as anger. The information generating unit 17, for example, may recognize a feeling from facial expressions. To recognize a feeling from facial expressions, a technique may be used that is disclosed in, for example, D. Parikh, K. Grauman, Relative Attributes, ICCV 2011.

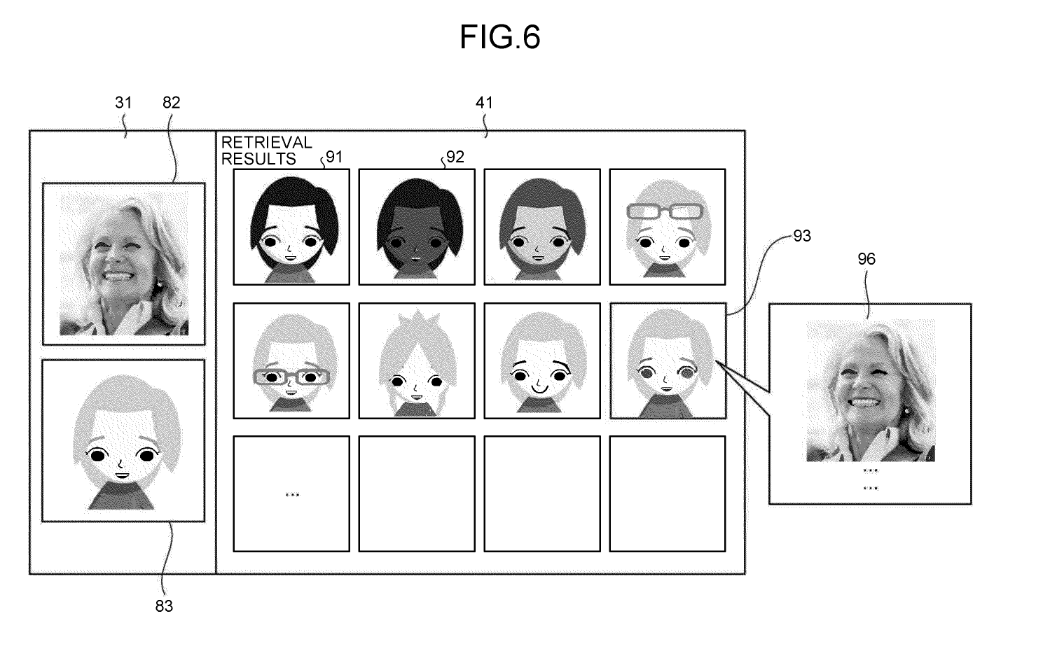

FIG. 6 is a diagram illustrating an example of a display screen of a second modification. In the example illustrated in FIG. 6, on the query display area 31, a thumbnail image 82 of the first image and a first symbol image 83 are displayed. On the retrieval result display area 41, second symbol images 91 to 93 and other images retrieved are displayed. In the example illustrated in FIG. 6, the second symbol image 93 is selected (not illustrated), and a second image 96 contained in a record containing the second symbol image 93 is further displayed.

In the example illustrated in FIG. 6, the element information is information indicating the category, the position, the size, the shape, and the color of the one or more components and the category of the first image.

Third Modification

In the first embodiment, the image based on the second image may be a thumbnail image of the second image contained in the record retrieved by the retrieval unit 19. When the thumbnail image of the second image displayed on the display unit 25 is designated or selected, the display controller 23 may further display the second symbol image contained in the record containing the second image on the display unit 25.

In the first embodiment, instead of simultaneously displaying the thumbnail image of the first image and the first symbol image, either one image may be displayed, and when the one image is designated or selected, the other image may be displayed.

Fourth Modification

In the first embodiment, a record that associates the first image, the first element information, and the first symbol image with each other may be recorded in the storage unit 11. Thus, the record that associates the first image, the first element information, and the first symbol image with each other can be added to an object to be searched for in the next and subsequent times.

For example, modes may be divided into a retrieval mode and a registration mode, and in the registration mode, the record that associates the first image, the first element information, and the first symbol image with each other may be recorded in the storage unit 11 without performing a retrieval.

Fifth Modification

Although, in the first embodiment, an example is described in which the storage unit 11 also stores therein the second symbol images, instead of storing the second symbol images in the storage unit 11, the second symbol images may be generated from the second element information retrieved.

Sixth Modification

Although, in the first embodiment, an example is described in which the retrieval apparatus 10 includes the storage unit 11, the storage unit 11 may be provided outside (on a cloud, for example) the retrieval apparatus 10. Any component other than the storage unit 11 included in the retrieval apparatus 10 may be formed into a cloud. The retrieval apparatus 10 may be implemented by a plurality of distributed apparatuses.

### Second Embodiment

In a second embodiment, an example will be described in which the first element information is changed to the first element information intended by the user by editing the first symbol image, and a retrieval is performed based on the changed first element information. The following mainly describes points of difference from the first embodiment. Components having functions similar to those of the first embodiment will be attached with names and numerals similar to those of the first embodiment, and descriptions thereof will be omitted.

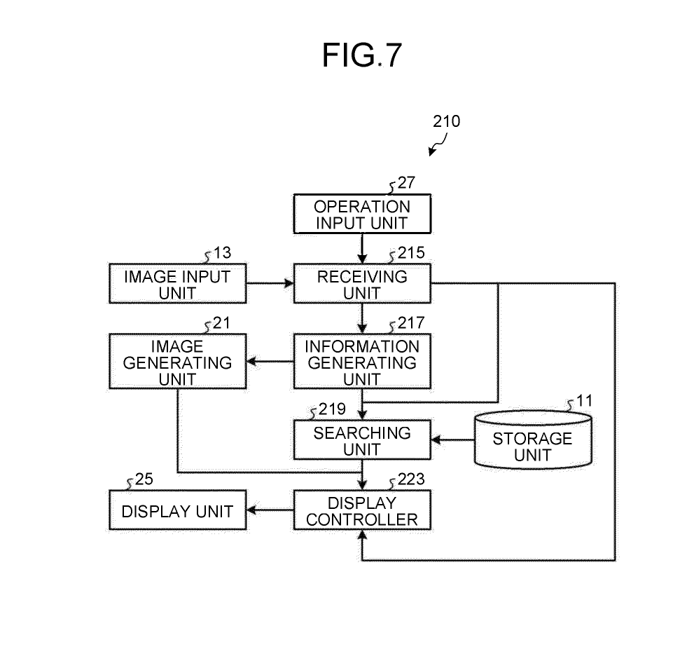

FIG. 7 is a configuration diagram illustrating an example of a retrieval apparatus 210 of the second embodiment. As illustrated in FIG. 7, the retrieval apparatus 210 of the second embodiment is different from the first embodiment in a receiving unit 215, an information generating unit 217, a retrieval unit 219, and a display controller 223.

In the first embodiment, when the input of the first image is received by the receiving unit 15, the retrieval unit 19 performs a retrieval using the first element information generated by the information generating unit 17. However, in the second embodiment, a retrieval is performed after retrieval operation input is received by the receiving unit 215.

For this reason, the display controller 223 displays the first symbol image on the display unit 25 before a retrieval is performed by the retrieval unit 219.

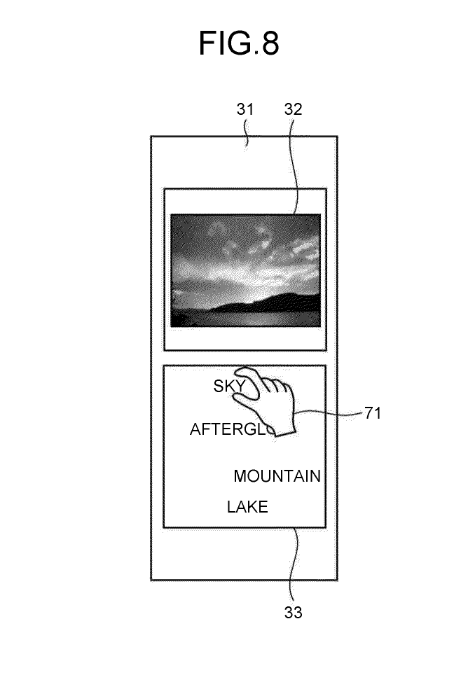

FIG. 8 is a diagram illustrating an example of the query display area 31 of a display screen of the second embodiment. In the example illustrated in FIG. 8, on the query display area 31, the thumbnail image 32 of the first image, the first symbol image 33, and a cursor 71 are displayed.

The receiving unit 215 further receives change input that changes the one or more first components constituting the first symbol image. Specifically, the receiving unit 215 receives operation input that changes a symbol on the first symbol image from the operation input unit 27.

Examples of the operation input that changes the symbol include pieces of operation input such as, after selecting the symbol with the cursor 71, changing the category, displacing the position of the symbol, changing the size of the symbol, changing the shape of the symbol, changing the color of the symbol, and deleting the symbol.

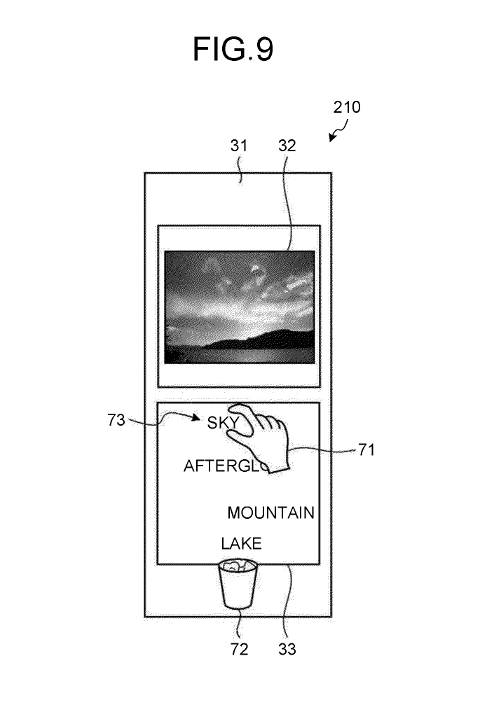

FIG. 9 is a diagram illustrating an example of a symbol deleting operation of the second embodiment. In the example illustrated in FIG. 9, a delete icon 72 is displayed, and a symbol 73 is selected with the cursor 71. The symbol 73 is moved to the delete icon 72 with the cursor 71, thereby deleting the symbol 73.

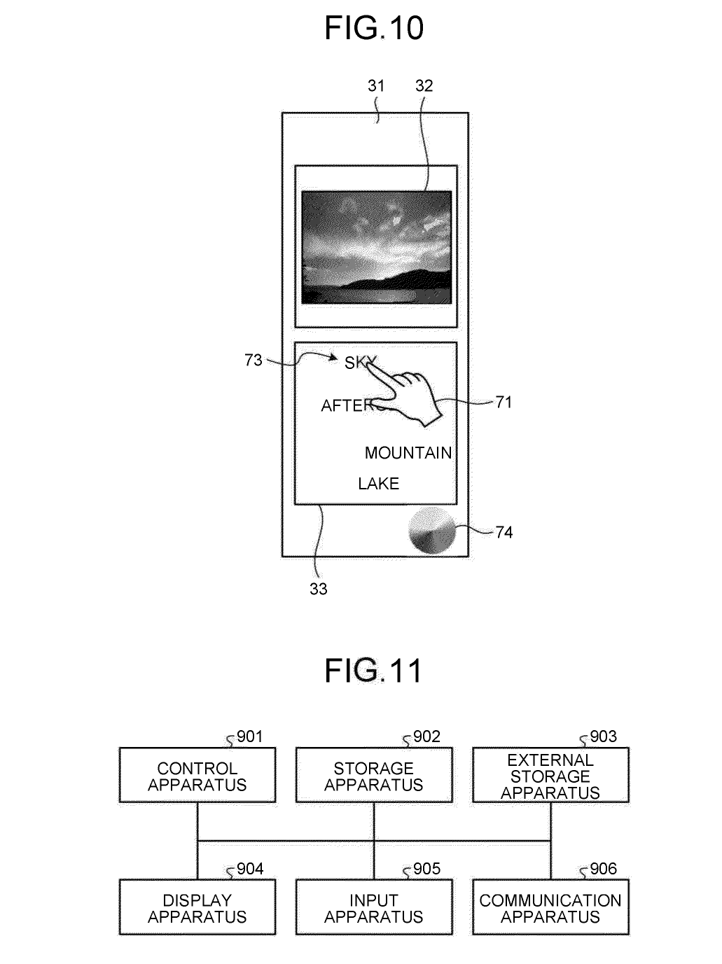

FIG. 10 is a diagram illustrating an example of a symbol color changing operation of the second embodiment. In the example illustrated in FIG. 10, a color change icon 74 is displayed, and the symbol 73 is selected with the cursor 71. A color is changed on the color change icon 74, thereby changing the color of the symbol 73.

The information generating unit 217 changes the first element information generated earlier based on the change input received by the receiving unit 215. Specifically, the information generating unit 217 makes the change so that the first element information generated earlier is the first element information of the changed first symbol image.

When the retrieval operation input is input from the operation input unit 27 and is received by the receiving unit 215, if it is before the change of the first element information, the retrieval unit 219 retrieves the second image based on the first element information generated by the information generating unit 217, and if it is after the change of the first element information, the retrieval unit 219 retrieves the second image based on the first element information changed by the information generating unit 217.

The display controller 223 then further displays an image based on the second image retrieved by the retrieval unit 219 on the display unit 25.

As described above, the second embodiment, in addition to the effect of the first embodiment, can generate the first element information intended by the user, and even when an intended first image is absent, a retrieval based on the intended first imaged can be achieved.

Seventh Modification

The second embodiment may be modified similarly to the first modification through the sixth modification.

Hardware Configuration

FIG. 11 is a diagram illustrating a hardware configuration example of the above retrieval apparatuses of the embodiments and the modifications. The retrieval apparatuses of the above embodiments and modifications each include a control apparatus 901 such as a CPU, a storage apparatus 902 such as a ROM and a RAM, an external storage apparatus 903 such as a ADD, a display apparatus 904 such as a display, an input apparatus 905 such as a keyboard and a mouse, and a communication apparatus 906 such as a communication interface, which is a hardware configuration using a typical computer.

A computer program executed by the retrieval apparatuses of the above embodiments and modifications is recorded and provided in a computer-readable recording medium such as a CD-ROM, a CD-R, a memory card, a digital versatile disc (DVD), and a flexible disk (FD) as an installable or executable file.

The computer program executed by the retrieval apparatuses of the above embodiments and modifications may be stored in a computer connected to a network such as the Internet and provided by being downloaded via the network. Furthermore, the computer program executed by the retrieval apparatuses of the above embodiments and modifications may be provided or distributed via a network such as the Internet. The computer program executed by the retrieval apparatuses of the above embodiments and modifications may be stored in a ROM to be provided, for example.

The computer program executed by the retrieval apparatuses of the above embodiments and modifications is modularized to implement the above units on a computer. As actual hardware, the CPU reads the computer program from the ADD, loads the computer program thus read to the RAM, and executes the computer program, thereby implementing the above units on the computer.

As described above, the above embodiments and modifications enable users to understand how input images have been interpreted to retrieve images to be searched for.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A retrieval apparatus comprising:
a receiver configured to receive a first image;
a retrieval processor configured to retrieve a second image based on first element information, the first element information comprising one or more of a category, a position, a size, a shape, and a color associated with the first image, the first image comprising one or more first image elements; and
a display controller configured to display, the second image with at least a first symbol image symbolizing the one or more first image elements on a display.

2. The apparatus according to claim 1, further comprising an information generator configured to generate the first element information from the first image.

3. The apparatus according to claim 1, further comprising an image generator configured to generate the first symbol image based on the first element information.

4. The apparatus according to claim 1, wherein,
the retrieval processor retrieves a record comprising second element information, wherein the record is identified based on a similarity between the second element information and the first element information, the record retrieved from a memory storing a plurality of records each of which associate the second image with the second element information and a second symbol image symbolizing one or more second image elements, wherein
the second element information comprises one or more of a category, a position, a size, a shape, and a color associated with the second image, the second symbol image comprising the one or more second image elements.

5. The apparatus according to claim 4, wherein the second symbol image is included in the retrieved record.

6. The apparatus according to claim 5, wherein when the second symbol image displayed on the display is designated or selected, the display controller further displays a thumbnail image of the second image contained in the retrieved record on the display.

7. The apparatus according to claim 4, wherein the image generator is configured to generate the first symbol image based on the first element information, wherein
when n (n≧2) records have been retrieved, the image generator further generates m (2≦m≦n) representative symbol images based on the first symbol image or n second symbol images contained in the n records, and
the display controller classifies the n second symbol images into the m representative symbol images and displays m representative symbol images, each of which being accompanied with number information, the number information indicating the number of the second symbol images classified into each of the m representative images on the display.

8. The apparatus according to claim 4, wherein when n (n≧2) records have been retrieved, the display controller displays the n second symbol images contained in the n records in order of similarity to the first symbol image on the display.

9. The apparatus according to claim 1, wherein the first image and the second image are face images.

10. The apparatus according to claim 9, wherein the first element information comprises one or more of the category, the position, the size, the shape, and the color associated with the first image.

11. The apparatus according to claim 1, wherein the one or more first image elements comprises a first category associated with a plurality of first image elements associated with the first image.

12. The apparatus according to claim 1, wherein the display controller further displays a thumbnail image of the first image on the display.

13. The apparatus according to claim 1, wherein the second symbol image is a thumbnail image of the second image contained in the retrieved record.

14. A retrieval apparatus comprising:
a receiver configured to receive a first image; and
a display controller configured to display a first symbol image symbolizing one or more first image elements of the first image on a display, based on first element information comprising one or more of a category, a position, a size, a shape, and a color associated with the first image, wherein
the receiver further receives a change input that changes the one or more first image elements associated with the first symbol image,
the retrieval apparatus further comprises a retrieval processor configured to retrieve a second image based on the first element information that has been changed based on the change input, and
the display controller further displays the second image on the display.

15. A retrieval method comprising:
receiving a first image;
retrieving a second image based on first element information, the first element information comprising one or more of a category, a position, a size, a shape, and a color associated with the first image, the first image comprising one or more first image elements; and
displaying, based on the first element information, the second image with at least a first symbol image symbolizing the one or more first image elements of the first image on a display.

16. A retrieval method comprising:
receiving a first image;
displaying, a first symbol image symbolizing one or more first image elements of the first image on a display, based on first element information comprising one or more of a category, a position, a size, a shape, and a color associated with the first image;
receiving a change input that changes the one or more first image elements associated with the first symbol image;
retrieving a second image based on the first element information that has been changed based on the change input; and
displaying the second image on the display.

17. A computer program product comprising a computer-readable medium including programmed instructions, the programmed instructions causing a computer to execute:
receiving a first image;
retrieving a second image based on first element information, the first element information comprising one or more of a category, a position, a size, a shape, and a color associated with the first image, the first image comprising one or more first image elements; and
displaying, based on the first element information, the second image with a first symbol image symbolizing the one or more first image elements of the first image on a display.

18. A computer program product comprising a computer-readable medium including programmed instructions, the programmed instructions causing a computer to execute:
receiving a first image;
displaying, a first symbol image symbolizing one or more first image elements of the first image on a display, based on first element information comprising one or more of a category, a position, a size, a shape, and a color associated with the first image;
receiving a change input that changes the one or more first image elements associated with the first symbol image;
retrieving a second image based on the first element information that has been changed based on the change input; and
displaying the second image on the display.
